(19) United States
(12) Patent Application Publication
(10) Pub. No.: US 2009/0025181 A1
(43) Pub. Date: Jan. 29, 2009

(54) Slow Closing Hinge Apparatus

(76) Inventor: George Burger, Rocklin, CA (US)

Correspondence Address: MIDDLETON & REUTLINGER, 2500 BROWN & WILLIAMSON TOWER, LOUISVILLE, KY, 40202, US

(21) Appl. No.: 11/828,868

(22) Filed: Jul. 26, 2007

(51) Int. Cl. E05D 11/00

(52) U.S. Cl. 16/286; 16/308

(57) ABSTRACT

The present invention provides a self-closing hinge suitable for use in a variety of applications where it is desirable to provide for automatic closing of a hinged member in a delayed or slow fashion. The invention includes a generally cylindrical outer casing or housing that partially encloses a rotatable shaft that may be secured to a hinged member to effect the rotation thereof. The shaft is disposed within a recess in a cylindrical coupler that is engaged by the shaft during rotation in a first direction—generally an “open” rotational direction—and that engages the shaft to rotate it in a second direction—generally a “closed” rotational direction. The coupler is secured to a torsional spring that acts against the open rotation of the shaft and thereby forces the coupler to rotate in a closed direction. Additionally, a rotatable inner casing, which is generally cylindrical, may be disposed within the outer casing in close proximity thereto, such that a high viscosity fluid may be disposed therebetween.

### BACKGROUND OF THE INVENTION

1. Field of the Invention

The present invention relates generally to a hinge mechanism and more specifically to a self-closing hinge system for controlling a rate of rotation capable of being mounted to any device requiring closing such as a door or toilet seat wherein the hinge system slowly returns the device to a closed position through stored energy means.

2. Description of the Related Art

In many circumstances, it is desirable to provide a hinge mechanism which maintains a device, or a hinged member, in a predetermined open or closed position and further, when opened or closed, returns said hinged member to its predetermined positioned at a relatively slow and constant rate. This is particularly desirable in the case of such hinged members as toilet seats, cabinet doors, exterior doors, and flip-open type cellular telephones where a dampened return to a predetermined position is helpful to the user.

In some prior art self-closing hinge devices, a spring bias member is secured between the hinged member and the device whereby the hinged member is opened against the force of the spring member. When the hinged member is released the force provided by the spring acts to force the hinged member to its closed position. This simple type of self-closing hinge device is unsatisfactory in many cases because the hinged member is forced back too quickly, thus slamming it to its closed position. Where devices of this type are installed on, for example, toilet seats, the seat slams down against the toilet base, thereby causing a great deal of noise. Furthermore, the seat is being forced downwardly (closed) by the spring tension at all times, thereby requiring it to be held in its up or open position.

To overcome these difficulties, some prior art hinge mechanisms have employed dampening systems to inhibit the quick closing tendencies of spring-biased self-closing hinges. Prior art dampening hinge mechanisms comprise complex combinations of axial elements, cams, viscoelastic fluids, bearings and the like to provide hinges wherein the opening and or closing speed of the hinge mechanism can be regulated.

Many prior art dampening mechanisms that utilize dampening systems unnecessarily limit or regulate the opening speed of the hinge, which is highly undesirable when said hinge is utilized in conjunction with a door or cabinet door. In such environments it is preferable to be able to open the door at an unregulated speed wherein the hinge “keeps up” with the rotational motion of the door and then slowly closes the door.

Accordingly, there is a need in the art for a self-closing hinge apparatus that is simple and economical to manufacture and produce and that does not limit its rate of rotation in a first direction, while maintaining the ability to regulate its rate of rotation in a second direction.

### SUMMARY OF THE INVENTION

The present invention provides a self-closing hinge suitable for use in a variety of applications where it is desirable to provide for automatic closing of a hinged member in a delayed or slow fashion. The invention described and claimed herein may be advantageously employed in toilet seats or lids, ingress and egress doors, cabinet doors or even flip-top style cellular phones.

The invention includes a generally cylindrical outer casing or housing that partially encloses a rotatable shaft that may be secured to a hinged member to effect the rotation thereof. The shaft is disposed within a recess in a cylindrical coupler that is engaged by the shaft during rotation in a first direction—generally an “open” rotational direction—and that engages the shaft to rotate it in a second direction—generally a “closed” rotational direction.

The coupler is secured to a torsional spring that acts against the open rotation of the shaft and thereby forces the coupler to rotate in a closed direction. Additionally, a rotatable inner casing, which is generally cylindrical, may be disposed within the outer casing in close proximity thereto, such that a high viscosity fluid may be disposed therebetween. The coupler includes a race around a portion thereof that is engaged by a clutch bearing. The clutch bearing engages the inner casing and the coupler when the coupler is rotating in the “closed” direction so that the coupler rotates closed against the force of the inner casing rotating relative to the outer casing.

In this fashion, the coupler, and thus the shaft that is engaged thereby, slowly rotate to a closed position once an opening rotational force ceases to be applied to the shaft.

Other features and advantages of the present invention will become apparent from the detailed description of the preferred embodiments herein below in conjunction with the drawing Figures appended hereto.

### BRIEF DESCRIPTION OF THE DRAWING FIGURES

FIG. 1 is an perspective view of a slow-closing hinge in accordance with one embodiment of the present invention.

FIG. 2 is a cross-sectional view of the slow-closing hinge taken along the line 2-2 of FIG. 1 in accordance with one embodiment of the present invention.

FIG. 3 is cross-sectional view of the slow-closing hinge taken along the line 3-3 of FIG. 2 in accordance with one embodiment of the present invention.

FIG. 4 is a cross-sectional view of the slow-closing hinge taken along the line 4-4 of FIG. 2 in accordance with one embodiment of the present invention.

FIG. 5 is a cross-sectional view of the slow-closing hinge taken along the line 4-4 of FIG. 2 showing the hinge at rest in accordance with one embodiment of the present invention.

FIG. 6 is a cross-sectional view of the slow-closing hinge taken along the line 4-4 of FIG. 2 showing the hinge being opened in accordance with one embodiment of the present invention.

FIG. 7 is a cross-sectional view of the slow-closing hinge taken along the line 4-4 of FIG. 2 showing the hinge closing in accordance with one embodiment of the present invention.

FIG. 8 is a cross-sectional view of the slow-closing hinge taken along the line 4-4 of FIG. 2 showing the hinge being actively closed in accordance with one embodiment of the present invention.

FIG. 9 is a cross-sectional view of the slow-closing hinge taken along the line 4-4 of FIG. 2 showing the hinge at rest in accordance with one embodiment of the present invention.

FIG. 10 is a cross-sectional view of the slow-closing hinge taken along the line 4-4 of FIG. 2 showing the hinge being opened in accordance with one embodiment of the present invention.

FIG. 11 is a cross-sectional view of the slow-closing hinge taken along the line 4-4 of FIG. 2 showing the hinge closing in accordance with one embodiment of the present invention.

FIG. 12 is a cross-sectional view of the slow-closing hinge taken along the line 4-4 of FIG. 2 showing the hinge being actively closed in accordance with one embodiment of the present invention.

### DETAILED DESCRIPTION OF THE PREFERRED EMBODIMENT(S)

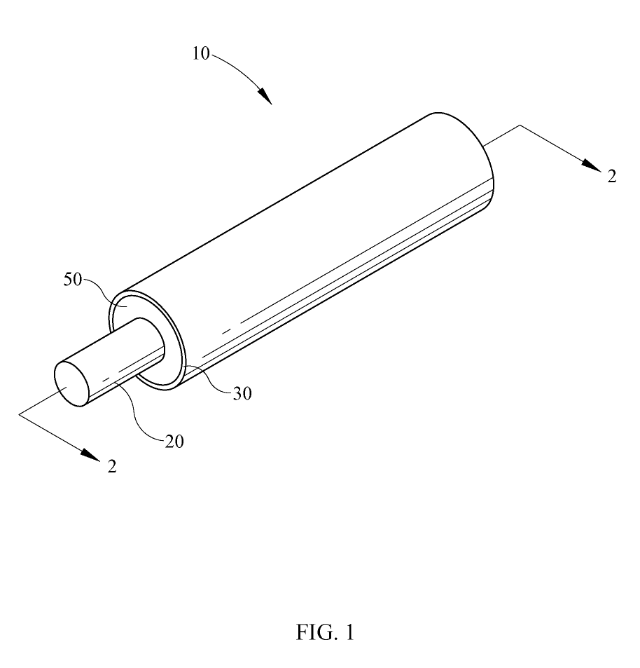

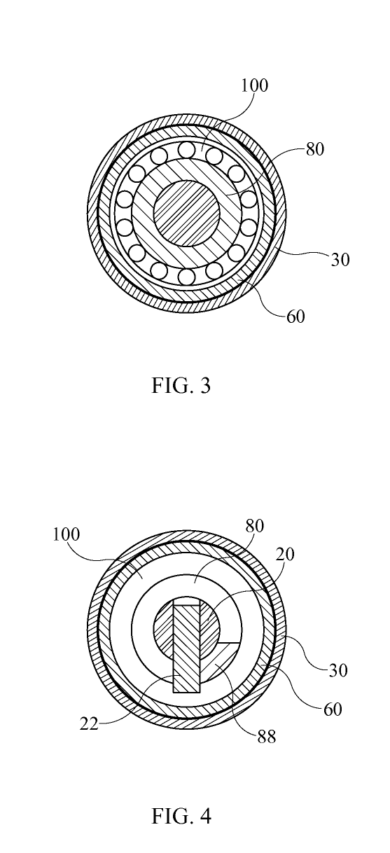

Referring now to drawing FIGS. 1-4, and in accordance with one embodiment of the present invention, a self-closing hinge apparatus 10 comprises a rotatable shaft 20 that may be secured to a hinged member (not shown) to effect rotation thereof. Rotatable shaft 20 is generally cylindrical in shape and extends axially inwardly into an outer casing 30 which is also generally cylindrical and tubular in shape. A bottom end 32 of outer casing 30 accepts a bottom end cap 40 to close the bottom end of outer casing 30 while a top end 34 of outer casing 30 is engaged by a top end cap 50 having an aperture 52 therein. Shaft 20 extends through aperture 52 and is rotatable therein. In one embodiment of the invention, bottom end cap 40 is integral to outer casing 30 such that end cap 40 and outer casing 30 are formed of the same piece of material.

A generally cylindrical and tubular inner casing 60 is disposed radially inwardly of, and in close proximity to outer casing 30. A bottom end 62 of casing 60 abuts bottom end cap 40. A Top end 64 of casing 60 is engaged by an annular fluid seal 70 that rests in an annular groove 54 in top end cap 50. In one embodiment of the present invention, a high viscosity fluid is disposed between rotatable inner casing 60 and outer casing 30 to inhibit the rotation of inner casing 60 relative to outer casing 30. Fluid seal 70 prevents the escape of the high viscosity fluid between inner casing 60 and outer casing 30. Additionally, bottom end cap 40 may also have an annular groove 44 that is engaged by a fluid seal 70 to prevent escape of the high viscosity fluid. As one example, high viscosity fluid may comprise a pure silicon fluid having a viscosity of 20,000,000 centiStokes (cSt) that is disposed in the generally annular area between rotatable inner casing 60 and outer casing 30. It should be noted that a range of fluid viscosities may be employed in various embodiments of the present invention, depending upon the dampening effect desired for a particular hinge application. More viscous fluid would act to provide a more slowly closing hinge.

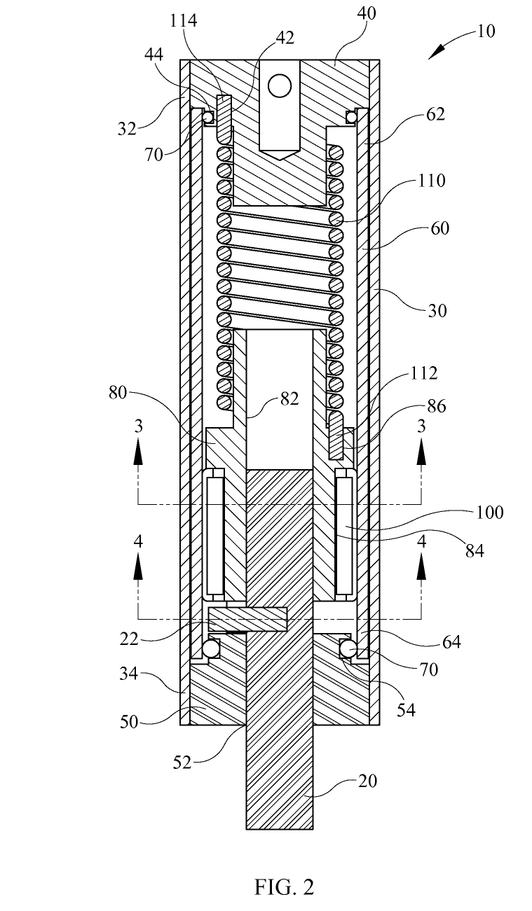

Referring now to FIGS. 2-4 the self-closing hinge 10 further comprises a coupler 80 having a generally cylindrical aperture or recess 82 therein to accept shaft 20 as it extends into aperture 82. Coupler 80 further includes a race 84 that extends around a radially outward portion thereof, said race 84 shaped to engage a clutch bearing 100 that is generally annular and disposed around race 84 between coupler 80 and inner casing 60 as best seen in FIG. 2. Clutch bearing 100 may be, for example, a needle type bearing that permits the free rotation of coupler 80 relative to inner casing 60 in a first, or “open” rotational direction. Clutch bearing 100 then engages coupler 80 race 84 and inner casing 60 when coupler 80 is rotating in a second or “closed” rotational direction thereby causing inner casing 60 to turn with coupler 80 in the closed direction.

Coupler 80 may further include a spring aperture 86 into which a first end 112 of a torsional spring 110 is inserted. As shown in FIG. 2, a second end 114 of torsional spring 110 is inserted into an aperture 42 or slot of end cap 40, thereby capturing torsional spring between end cap 40 and coupler 80 such that rotation of coupler 80 in an open direction acts against the force of torsional spring 110.

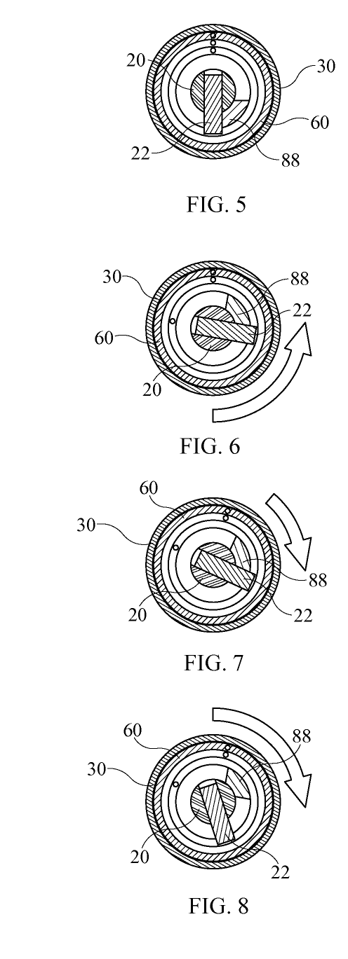

As best seen in FIGS. 4-12, coupler 80 further includes a contact portion 88 at an upper end thereof that extends only partially around the circumference of coupler 80. Contact portion 88 engages a pin 22 that extends radially outwardly from shaft 20 as shaft 20 rotates in an open direction. As best seen in FIGS. 4-7 contact portion 88 is engaged by pin 22 as shaft 20 rotates in an open direction. FIG. 5 depicts the self-closing hinge 10 at rest. FIG. 6 depicts shaft 20 and pin 22 rotating in an open direction as caused by, for example, the opening of a hinged member such as a cabinet door. Coupler 80 is also forced to rotate against torsional spring 110 force as contact portion 88 is engaged by pin 22.

FIG. 7 depicts hinge 10 rotating closed. Torsional spring 110 forces coupler 80, and thus contact portion 88 to rotate in a closed direction, thereby rotating pin 22 and shaft 20 in a closed direction. Simultaneously, clutch bearing 100 engages race 84 and inner casing 60 thereby requiring inner casing 60 to rotate with coupler 80 in the closed direction. This mechanism supplies a dampening force against the torsional closing force of spring 110, thereby permitting shaft 20 to slowly rotate to a closed position as contact portion 88 bears on pin 22.

Additionally, as seen in FIG. 8, shaft 20 may rotate freely within coupler 80 in a closed direction, so that a hinged member may be actively closed without the dampening oppositional force provided by the interaction of the coupler 80, clutch bearing 100 and inner casing 60.

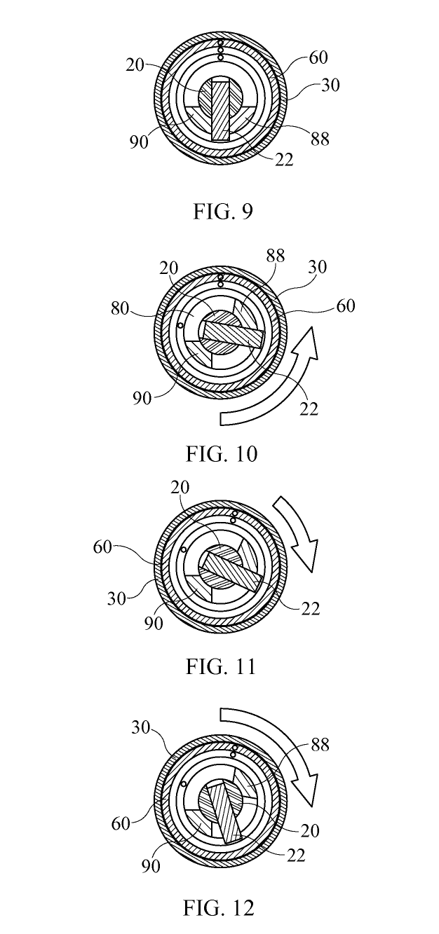

FIGS. 9-12 depict an alternative embodiment of the invention wherein a stop protrusion 90 that extends radially inwardly to arrest the rotation of pin 22 and thus shaft 20 as it returns to a closed position. FIG. 9 depicts the hinge 10 at rest while FIG. 10 depicts the device being opened and thus energized. FIG. 11 shows the device 10 rotating to a closed position as coupler 80 contact portion 88 engages pin 22. FIG. 12 shows the hinge 20 being actively closed so that shaft 20 rotates freely of coupler 80.

In a further embodiment of the present invention inner casing 60 and clutch bearing 100 are omitted entirely so that the closing force provided by torsional spring 110 is not dampened. Additionally, in one embodiment of the invention, pin 22 of shaft 20 are formed of a single piece of material such that pin 22 and shaft 20 are unitary in construction. Additionally, pin 22 is not required to be shaped as a pin, but may be shaped as any protrusion suitable for engaging with contact portion 88 of coupler 88.

In a yet further embodiment of the invention coupler 80 and shaft 20 may be an integral or unitary assembly such that no contact portion 88 or pin 22 are required for operation. In this embodiment of the invention, the coupler 80 and shaft 20 unit always rotate open and closed together, so that when rotating in a closed direction, the dampening force provided by the relative motion of inner casing 60 rotating against outer casing 30 is always present.

While the present invention has been shown and described herein in what are considered to be the preferred embodiments thereof, illustrating the results and advantages over the prior art obtained through the present invention, the invention is not limited to those specific embodiments. Thus, the forms of the invention shown and described herein are to be taken as illustrative only and other embodiments may be selected without departing from the scope of the present invention, as set forth in the claims appended hereto.

I claim:

1. A self-closing hinge comprising:
a cylindrical outer casing;
a shaft disposed radially inwardly of said outer casing and rotatable about a longitudinal axis, said shaft having an integral coupler that rotates therewith; and
a torsional spring secured at one end thereof to said coupler for biasing said shaft in a first rotational direction.

2. A self-closing hinge as claimed in claim 1 comprising:
a rotatable inner casing disposed between said outer casing and said coupler.

3. A self-closing hinge as claimed in claim 2 comprising:
a race disposed circumferentially around a portion of said coupler; and
a clutch bearing disposed between said race and said rotatable inner casing wherein said clutch bearing engages said inner casing when said shaft rotates in said first direction and permits free rotation of said shaft in an opposite rotational direction.

4. A self-closing hinge as claimed in claim 2 comprising:
a high viscosity fluid disposed between said inner casing and said outer casing to slow rotation of said inner casing relative to said outer casing.

5. A self-closing hinge as claimed in claim 3 comprising:
a high viscosity fluid disposed between said inner casing and said outer casing to slow rotation of said inner casing relative to said outer casing.

6. A self-closing hinge as claimed in claim 1 comprising:
an end cap engaging a first end of said outer casing having an aperture therein for engaging a distal end of said torsional spring.

7. A self-closing hinge as claimed in claim 1 comprising:
a front cap engaging a second end of said outer casing having an aperture therein through which an end of said rotatable shaft protrudes, whereby said shaft end may be secured to a hinged member.

8. A self-closing hinge comprising:
an outer cylindrical casing and a rotatable inner cylindrical casing disposed radially inwardly thereof;
a rotatable coupler disposed radially inwardly of said inner casing having a contact portion at an upper end thereof and having a cylindrical recess therein;
a rotatable shaft positioned within the cylindrical recess of said coupler, said shaft having a protrusion extending radially outwardly therefrom for engaging said coupler contact portion;
a torsional spring secured to said coupler for biasing said coupler in a first direction; and
wherein said shaft protrusion engages said contact portion of said coupler when rotated in a second direction, thereby rotating said coupler against the force of said spring.

9. A self closing hinge as claimed in claim 8 comprising:
a race disposed circumferentially around a portion of said coupler; and
a clutch bearing disposed between said race and said rotatable inner casing wherein said clutch bearing engages said inner casing when said shaft rotates in said first direction and permits free rotation of said shaft in an opposite rotational direction.

10. A self-closing hinge as claimed in claim 8 comprising:
a high viscosity fluid disposed between said inner casing and said outer casing to slow rotation of said inner casing relative to said outer casing.

11. A self-closing hinge as claimed in claim 9 comprising:
a high viscosity fluid disposed between said inner casing and said outer casing to slow rotation of said inner casing relative to said outer casing.

12. A self-closing hinge as claimed in claim 8 comprising:
an end cap engaging a first end of said outer casing having an aperture therein for engaging a distal end of said torsional spring.

13. A self-closing hinge as claimed in claim 8 comprising:
a front cap engaging a second end of said outer casing having an aperture therein through which an end of said rotatable shaft protrudes, whereby said shaft end may be secured to a hinged member.

14. A self-closing hinge as claimed in claim 8 further comprising:
a coupler having a stop portion contacting said shaft pin at a rotational home position.

15. A self-closing hinge as claimed in claim 8 further comprising:
a coupler having a recess therein for engaging a proximal end of said torsional spring.

16. A self-closing hinge as claimed in claim 12 further comprising:
an end cap having an annular seal ring disposed circumferentially around an interior portion thereof, and
an annular fluid seal engaging said seal ring and said inner casing.

17. A self-closing hinge as claimed in claim 16 further comprising:
a high viscosity fluid disposed between said inner casing and said outer casing to slow rotation of said inner casing relative to said outer casing.

18. A self-closing hinge comprising:
a cylindrical outer casing having a rotatable cylindrical inner casing disposed radially inwardly thereof;
a torsional spring disposed in said inner casing at a lower portion thereof;
an annular coupler rotatable about a longitudinal axis having a lower portion secured to said torsional spring, an upper portion having a contact ring extending circumferentially around a portion thereof, said coupler further having a cylindrical recess therein; and
a rotatable shaft disposed within said cylindrical recess of said coupler, said shaft having a pin extending radially outwardly from an upper portion thereof for engaging said contact ring of said coupler.

19. A self closing hinge as claimed in claim 18 comprising:
a coupler having a race disposed circumferentially around a central portion thereof; and
a clutch bearing disposed between said race and said rotatable inner casing wherein said clutch bearing engages said inner casing when said coupler rotates in a first direction and permits free rotation of said coupler in an opposite rotational direction.

20. A self-closing hinge as claimed in claim 11 wherein said high viscosity fluid comprsises a silicon fluid.

21. A self-closing hinge as claimed in claim 20 wherein said high viscosity fluid has a kinematic viscosity in the range of 10-20 million cSt thereby dampening the rotation of said inner casing.
